(19) United States
(12) Patent Application Publication
(10) Pub. No.: US 2020/0176771 A1
(43) Pub. Date: Jun. 4, 2020

(54) NON-AQUEOUS ELECTROLYTE SECONDARY BATTERY

(71) Applicant: Panasonic Intellectual Property Management Co., Ltd., Dsaka-shi, Osaka (JP)

(72) Inventors: Yuji Tani, Osaka (JP); Satoshi Nishitani, Osaka (JP); Masaki Deguchi, Hyogo (JP)

(73) Assignee: Panasonic Intellectual Property Management Co., Ltd., Osaka-shi, Osaka (JP)

(21) Appl. No.: 16/639,377

(22) PCT Filed: Sep. 11, 2018
(86) PCT No.: PCT/JP2018/033526

§ 371 Date: Feb. 14, 2020

(30) Foreign Application Priority Data
Sep. 29, 2017 (JP) 2017-191272

(51) Int. Cl. H01M 4/525; H01M 10/0569; H01M 10/052; H01M 10/0567; H01M 4/02

(52) U.S. Cl. CPC H01M 4/525; H01M 10/0569; H01M 2004/028; H01M 10/0567; H01M 10/052

(57) ABSTRACT

A non-aqueous electrolyte secondary battery including a positive electrode, a separator, a negative electrode facing the positive electrode with the separator interposed therebetween, and an electrolytic solution containing a solvent and an electrolyte. The positive electrode includes a positive electrode material containing a lithium-nickel composite oxide represented by LiₐNi_{b}M_{1-b}O₂, where M represents at least one selected from the group consisting of Na, Mg, Sc, Y, Mn, Fe, Co, Ni, Cu, Zn, Al, Cr, Pb, Sb and B, 0.95≤a≤1.2, and 0.8≤b≤1. The electrolytic solution contains an ester compound C of an alcohol compound A and a carboxylic acid compound B, and contains at least one of the alcohol compound A and the carboxylic acid compound B in an amount of 15 ppm or more, relative to a mass of the electrolytic solution.

### TECHNICAL FIELD

The present invention mainly relates to an improvement of an electrolytic solution of a non-aqueous electrolyte secondary battery.

### BACKGROUND ART

A non-aqueous electrolyte secondary battery, especially a lithium ion secondary battery, has high voltage and high energy density, and therefore is expected as a power source for small consumer applications, power storage devices, and electric vehicles. With increasing demand for higher energy density of the battery, there has been an increasing expectation for a lithium-nickel composite oxide to be utilized as a positive electrode active material having high theoretical capacity density.

Examples of the lithium-nickel composite oxide include a series of compounds represented by a composition formula: LiₐNi_{b}M_{1-b}O₂. Element M is, for example, selected from the group consisting of Na, Mg, Sc, Y, Mn, Fe, Co, Ni, Cu, Zn, Al, Cr, Pb, Sb and B. The higher the Ni ratio b is, the more likely a higher capacity can be achieved.

On the other hand, Patent Literature 1 discloses using an ester compound as a solvent of an electrolytic solution, thereby to improve the cycle characteristics.

### CITATION LIST

### Patent Literature

[PTL 1] Japanese Laid-Open Patent Publication No. 2004-172120

### SUMMARY OF INVENTION

In a non-aqueous electrolyte secondary battery including a lithium-nickel composite oxide in a positive electrode, increasing the Ni ratio in the oxide results in increased leaching of alkali. In this case, when an electrolytic solution containing an ester compound is used, the decomposition reaction of the ester compound may be accelerated in a high temperature environment. As a result, excellent high-temperature storage characteristics become difficult to obtain.

In view of the above, one aspect of the present invention relates to a non-aqueous electrolyte secondary battery, including a positive electrode, a separator, a negative electrode facing the positive electrode with the separator interposed between the positive electrode and the negative electrode, and an electrolytic solution containing a solvent and an electrolyte,

the positive electrode including a positive electrode material containing a lithium-nickel composite oxide represented by LiₐNi_{b}M_{1-b}O₂, where M represents at least one selected from the group consisting of Na, Mg, Sc, Y, Mn, Fe, Co, Ni, Cu, Zn, Al, Cr, Pb, Sb and B, 0.95≤a≤1.2, and 0.8≤b≤1,

the electrolytic solution containing an ester compound C of an alcohol compound A and a carboxylic acid compound B, and containing at least one of the alcohol compound A and the carboxylic acid compound B in an amount of 15 ppm or more, relative to a mass of the electrolytic solution.

According to the non-aqueous electrolyte secondary battery of the present invention, excellent high-temperature storage characteristics can be maintained even in a non-aqueous electrolyte secondary battery using a lithium-nickel composite oxide in which the Ni ratio is high, as the positive electrode material.

### BRIEF DESCRIPTION OF DRAWING

FIG. 1 A schematic partially cut-away oblique view of a non-aqueous electrolyte secondary battery according to an embodiment of the present invention.

### DESCRIPTION OF EMBODIMENTS

A non-aqueous electrolyte secondary battery according to an embodiment of the present invention includes a positive electrode, a separator, a negative electrode facing the positive electrode with the separator interposed therebetween, and an electrolytic solution containing a solvent and an electrolyte. The positive electrode includes a positive electrode material. The positive electrode material contains a lithium-nickel composite oxide represented by LiₐNi_{b}M_{1-b}O₂ (M represents at least one selected from the group consisting of Na, Mg, Sc, Y, Mn, Fe, Co, Ni, Cu, Zn, Al, Cr, Pb, Sb and B, 0.95≤a≤1.2, 0.8≤b≤1). The above lithium-nickel composite oxide has a Ni ratio b of 0.8 or more, and can be expected to provide a high capacity. In particular, the element M preferably represents at least one selected from the group consisting of Mn, Co and Al.

In the non-aqueous electrolyte secondary battery according to an embodiment of the present invention, the electrolytic solution contains, as a solvent, an ester compound C of an alcohol compound A and a carboxylic acid compound B. When the Ni ratio in the lithium-nickel composite oxide is high, however, since this forms a strong alkali environment, the decomposition reaction of the ester compound C may be accelerated under high temperatures (specifically, 60° C. or higher). As a result, high capacity cannot be maintained in a high temperature environment.

To address the above, the electrolytic solution of the non-aqueous electrolyte secondary battery includes, in addition to the ester compound C, at least one of the alcohol compound A and the carboxylic acid compound B. By adding a decomposition product of the ester compound C, i.e., the alcohol compound A and/or the carboxylic acid compound B, into the electrolytic solution in advance, the equilibrium of the esterification reaction shifts toward the production side of the ester compound C, according to the Le Chatelier's principle. This can suppress the decomposition reaction of the ester compound C.

The amount of the alcohol compound A and/or the carboxylic acid compound B in the electrolytic solution at the time of preparation is 1 ppm or more, relative to the mass of the electrolytic solution. When the amount of the alcohol compound A and/or the carboxylic acid compound B in the electrolytic solution at the time of preparation is 1 ppm or more, the decomposition of the ester compound C can be sufficiently suppressed. The amount of the alcohol compound A in the electrolytic solution at the time of preparation is preferably 2 to 1000 ppm, more preferably 5 to 500 ppm, still more preferably 10 to 100 ppm, relative to the mass of the electrolytic solution. Likewise, the amount of the carboxylic acid compound B in the electrolytic solution at the time of preparation is preferably 2 to 1000 ppm, more preferably 5 to 500 ppm, still more preferably 10 to 100 ppm.

The amount of the alcohol compound A and/or the carboxylic acid compound B in the electrolytic solution in the non-aqueous electrolyte secondary battery after production is likely to increase (by about 10 ppm) from the amount in the electrolytic solution upon preparation. Preferably, in the battery in an initial state having undergone about 10 charge-discharge cycles or less, the amount of the alcohol compound A and/or the carboxylic acid compound B is, for each compound, 15 ppm or more, more preferably 15 to 1000 ppm, still more preferably 20 to 1000 ppm, relative to the mass of the electrolytic solution.

The amount of the alcohol compound A and the carboxylic acid compound B can be measured by taking out the electrolytic solution from the battery, and subjecting the solution to a gas chromatography mass spectrometry.

Note that the carboxylic acid compound B can be present not only in the form of R—COOH (R is an organic functional group) in the electrolytic solution, but also in the form of a carboxylate ion (R—COO⁻) or, in an alkali environment, in the form of a Li salt (R—COOLi). The amount of the carboxylic acid compound B is calculated with taking into account these compounds present in the form of a carboxylate ion or a salt.

The alcohol compound A preferably includes at least one selected from the group consisting of monoalcohols having 1 to 4 carbon atoms, and more preferably includes methanol. The carboxylic acid compound B preferably includes at least one selected from the group consisting of monocarboxylic acids having 2 to 4 carbon atoms.

Therefore, the ester compound C most preferably includes methyl acetate.

The ester compound C is contained preferably in an amount of 1 to 80%, relative to the volume of the electrolytic solution.

A detailed description will be given below of a non-aqueous electrolyte secondary battery according to an embodiment of the present invention. The non-aqueous electrolyte secondary battery includes, for example, a negative electrode, a positive electrode, and a non-aqueous electrolyte as described below.

[Negative Electrode]

The negative electrode includes, for example, a negative electrode current collector, and a negative electrode mixture layer formed on a surface of the negative electrode current collector and containing a negative electrode active material. The negative electrode mixture layer can be formed by applying a negative electrode slurry of a negative electrode mixture dispersed in a dispersion medium, onto a surface of the negative electrode current collector, and drying the slurry. The dry applied film may be rolled, if necessary. The negative electrode mixture layer may be formed on one surface or both surfaces of the negative electrode current collector.

The negative electrode mixture includes a negative electrode active material as an essential component, and may include a binder, an electrically conductive agent, a thickener, and other optional components. The negative electrode active material includes a material that electrochemically absorbs and releases lithium ions. The material that electrochemically absorbs and releases lithium ions may be, for example, a carbon material, or a material including silicon particles dispersed in a lithium silicate phase.

Examples of the carbon material include graphite, graphitizable carbon (soft carbon), and non-graphitizable carbon (hard carbon). Preferred among them is graphite, which is stable during charge and discharge cycles and whose irreversible capacity is small. The graphite means a material having a graphite-like crystal structure, examples of which include natural graphite, artificial graphite, and graphitized mesophase carbon particles. The carbon material may be used singly or in combination of two or more kinds.

A mixed active material including silicon particles dispersed in a lithium silicate phase (hereinafter sometimes referred to as “negative electrode material LSX”) absorbs lithium ions through alloying of silicon with lithium. Increasing the amount of the silicon particles in the material can be expected to result in a high capacity. The lithium silicate phase is preferably represented by a composition formula: Li_{y}SiO_{z} (0<y≤4, 0.2≤z≤5), more preferably by a composition formula: Li₂ᵤSiO₂₊ᵤ (0<u<2).

In the lithium silicate phase, the sites that can react with lithium are scarce as compared with in SiOₓ which is a composite of SiO₂ and fine silicon. The lithium silicate phase, therefore, is less likely to generate irreversible capacity associated with charge and discharge. When silicon particles are dispersed in the lithium silicate phase, excellent charge-discharge efficiency can be obtained at the early stage of charge and discharge. Moreover, the amount of silicon particles can be changed as desired, which enables to design a high-capacity negative electrode.

The crystallite size of the silicon particles dispersed in the lithium silicate phase is, for example, 10 nm or more. The silicon particles have a particulate phase of silicon (Si) elementary substance. When the crystallite size of the silicon particles is 10 nm or more, the surface area of the silicon particles can be suppressed small. Therefore, the silicon particle deterioration accompanied by generation of irreversible capacity is unlikely to occur. The crystallite size of the silicon particles can be calculated from the Scherrer formula, using a half-width of a diffraction peak attributed to the Si (111) plane of an X-ray diffractometry pattern of the silicon particle.

The negative active material may be a combination of the above-mentioned negative electrode material LSX and a carbon material. The negative electrode material LSX expands and contracts in volume in association with charge and discharge. Therefore, increasing the ratio thereof in the negative electrode active material may cause a contact failure between the negative electrode active material and the negative electrode current collector, in association with charge and discharge. On the other hand, by using the negative electrode material LSX and a carbon material in combination, a high capacity of the silicon particles can be imparted to the negative electrode, and excellent cycle characteristics can be achieved. The ratio of the negative electrode material LSX to the total of the negative electrode material LSX and the carbon material is preferably, for example, 3 to 30 mass %. In this case, a higher capacity as well as improved cycle characteristics tend to be achieved.

Examples of the negative electrode current collector includes a non-porous electrically conductive substrate (e.g., metal foil) and a porous electrically conductive substrate (e.g., mesh, net, punched sheet). The negative electrode current collector may be made of, for example, stainless steel, nickel, a nickel alloy, copper, or a copper alloy. The negative electrode current collector may have any thickness. In view of balancing between maintaining the strength and reducing the weight of the negative electrode, the thickness is preferably 1 to 50 μm, more preferably from 5 to 20 μm.

The binder may be a resin material, examples of which include: fluorocarbon resin, such as polytetrafluoroethylene and polyvinylidene fluoride (PVDF); polyolefin resin, such as polyethylene and polypropylene; polyamide resin, such as aramid resin; polyimide resin, such as polyimide and polyamide-imide; acrylic resin, such as polyacrylic acid, polymethyl acrylate, and ethylene-acrylic acid copolymer; vinyl resin, such as polyacrylnitrile and polyvinyl acetate; polyvinyl pyrrolidone; polyether sulfone; and a rubbery material, such as styrene-butadiene copolymer rubber (SBR). These may be used singly or in combination of two or more kinds.

Examples of the conductive agent include: carbon blacks, such as acetylene black; conductive fibers, such as carbon fibers and metal fibers; fluorinated carbon; metal powders, such as aluminum; conductive whiskers, such as zinc oxide and potassium titanate; conductive metal oxides, such as titanium oxide; and organic conductive materials, such as phenylene derivatives. These may be used singly or in combination of two or more kinds.

Examples of the thickener include: carboxymethyl cellulose (CMC) and modified products thereof (including salts, such as Na salt); cellulose derivatives (e.g., cellulose ether), such as methyl cellulose; saponificated products of a polymer having a vinyl acetate unit, such as polyvinyl alcohol; polyether (e.g., polyalkylene oxide, such as polyethylene oxide). These may be used singly or in combination of two or more kinds.

Examples of the dispersion medium include: water, alcohols, such as ethanol; ethers, such as tetrahydrofuran; amides, such as dimethylformamide; N-methyl-2-pyrrolidone (NMP); and a mixed solvent of these.

[Positive Electrode]

The positive electrode includes, for example, a positive electrode current collector, and a positive electrode mixture layer formed on a surface of the positive electrode current collector. The positive electrode mixture layer can be formed by applying a positive electrode slurry of a positive electrode mixture dispersed in a dispersion medium, onto a surface of the positive electrode current collector, and drying the slurry. The dry applied film may be rolled, if necessary. The positive electrode mixture layer may be formed on one surface or both surfaces of the positive electrode current collector.

The positive electrode active material may be a lithium-nickel composite metal oxide having a layered rock salt structure like LiCoO₂ and containing 80 mol % or more of Ni in the transition metal site. The positive electrode active material is preferably the above-mentioned lithium-nickel composite metal oxide LiₐNi_{b}M_{1-b}O₂ (0.95≤a≤1.2, 0.8≤b≤1). When the Ni ratio b is 0.8 or more, a high capacity can be expected. In view of achieving a higher capacity, the Ni ratio b is preferably 0.9 or more, more preferably 0.93 or more. It is to be noted, however, that the higher the Ni ratio b is, the stronger the alkalinity tends to be. Here, the lithium ratio a is a value measured in a fully discharged state or in an initial state upon production of the active material, which is subjected to increase and decrease during charge and discharge.

The element M preferably represents at least one selected from the group consisting of Mn, Co and Al. In view of the crystal structure stability, LiₐNi_{b}Co_{c}Al_{d}O₂ (0.95<a≤1.2, 0.8≤b<1, 0<c<0.15, 0<d≤0.1, b+c+d=1), where M represents Co and Al. Examples of the lithium-nickel composite oxide include a lithium-nickel-cobalt composite oxide (e.g., LiNi_{0.8}Co_{0.2}O₂) and a lithium-nickel-cobalt-aluminum composite oxide (e.g., LiNi_{0.8}Co_{0.15}Al_{0.05}O₂, LiNi_{0.8}Co_{0.18}Al_{0.02}O₂, LiNi_{0.9}Co_{0.05}Al_{0.05}O₂).

Examples of the binder and the conductive agent are as those exemplified for the negative electrode. The conductive agent may be graphite, such as natural graphite and artificial graphite.

The form and the thickness of the positive electrode current collector may be respectively selected from the forms and the range corresponding to those of the negative electrode current collector. The positive electrode current collector may be made of, for example, stainless steel, aluminum, an aluminum alloy, and titanium.

[Non-Aqueous Electrolyte]

The non-aqueous electrolyte contains a non-aqueous solvent, and a lithium salt dissolving in the non-aqueous solvent. The concentration of the lithium salt in the non-aqueous electrolyte is, for example, 0.5 to 2 mo/L. The non-aqueous electrolyte may contain a known additive.

The non-aqueous solvent may be, in addition to the chain carboxylic acid ester compound C as above, for example, a cyclic carbonic acid ester, a chain carbonic acid ester, or a cyclic carboxylic acid ester. Examples of the cyclic carbonic acid ester include propylene carbonate (PC) and ethylene carbonate (EC). Examples of the chain carbonic acid ester include diethyl carbonate (DEC), ethyl methyl carbonate (EMC), and dimethyl carbonate (DMC). Examples of the cyclic carboxylic acid ester include γ-butyrolactone (GBL) and γ-valerolactone (GVL). These non-aqueous solvents may be used singly or in combination of two or more kinds.

Examples of the lithium salt include a lithium salt of a chlorine-containing acid (e.g., LiClO₄, LiAlCl₄, LiB₁₀Cl₁₀), a lithium salt of a fluorine-containing acid (e.g., LiPF₆, LiBF₄, LiSbF₆, LiAsF₆, LiCF₃SO₃, LiCF₃CO₂), a lithium salt of a fluorine-containing acid imide (e.g., LiN(CF₃SO₂)₂, LiN(CF₃SO₂)(C₄F₉SO₂), LiN(C₂F₅SO₂)₂), and a lithium halide (e.g., LiCl, LiBr, LiI). These lithium salts may be used singly or in combination of two or more kinds.

[Separator]

Usually, it is desirable to interpose a separator between the positive electrode and the negative electrode. The separator is excellent in ion permeability and has moderate mechanical strength and electrically insulating properties. The separator may be, for example, a microporous thin film, a woven fabric, or a nonwoven fabric. The separator is preferably made of, for example, polyolefin, such as polypropylene or polyethylene.

In an exemplary structure of the non-aqueous electrolyte secondary battery, an electrode group formed by winding the positive electrode and the negative electrode with the separator interposed therebetween is housed together with the non-aqueous electrolyte in an outer case. The wound-type electrode group may be replaced with a different form of the electrode group, for example, a stacked-type electrode group formed by stacking the positive electrode and the negative electrode with the separator interposed therebetween. The non-aqueous electrolyte secondary battery may be in any form, such as cylindrical type, prismatic type, coin type, button type, or laminate type.

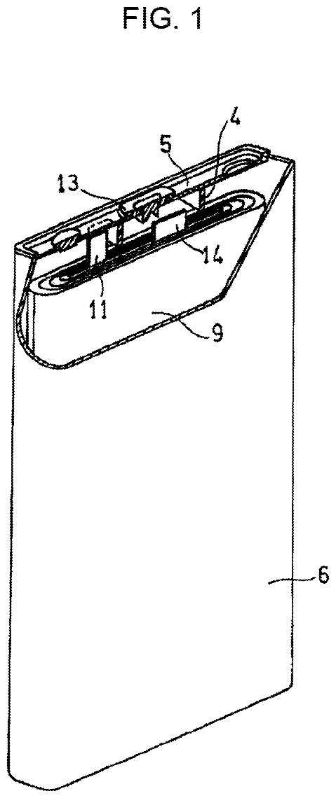

FIG. 1 is a schematic partially cut-away oblique view of a non-aqueous electrolyte secondary battery according to an embodiment of the present invention.

The battery includes a bottomed prismatic battery case 6, and an electrode group 9 and a non-aqueous electrolyte (not shown) housed in the battery case 6. The electrode group 9 has a long negative electrode, a long positive electrode, and a separator interposed between the positive electrode and the negative electrode and preventing them from directly contacting with each other. The electrode group 9 is formed by winding the negative electrode, the positive electrode, and the separator around a flat plate-like winding core, and then removing the winding core.

A negative electrode lead 11 is attached at its one end to the negative electrode current collector of the negative electrode, by means of welding or the like. A positive electrode lead 14 is attached at its one end to the positive electrode current collector of the positive electrode, by means of welding or the like. The negative electrode lead 11 is electrically connected at its other end to a negative electrode terminal 13 disposed at a sealing plate 5. The positive electrode lead 14 is electrically connected at its other end to a battery case 6 serving as a positive electrode terminal. A resin frame member 4 is disposed on top of the electrode group 9, the frame member serving to insulate the electrode group 9 from the sealing plate 5, as well as to insulate the negative electrode lead 11 from the battery case 6. The opening of the battery case 6 is sealed with the sealing plate 5.

The non-aqueous electrolyte secondary battery may be of cylindrical, coin, or button type having a battery case made of metal, or of laminate type having a battery case made of a laminated sheet which is a laminate of a barrier layer and a resin sheet.

The present invention will be specifically described below with reference to Examples and Comparative Examples. It is to be noted, however, the present invention is not limited to the following Examples.

### EXAMPLE 1

[Production of Negative Electrode]

Graphite was used as a negative electrode active material. The negative electrode active material was mixed with sodium carboxymethyl cellulose (CMC—Na) and styrene-butadiene rubber (SBR) in a mass ratio of 97.5:1:1.5, to which water was added. The mixture was stirred in a mixer (T.K. HIVIS MIX, available from PRIMIX Corporation), to prepare a negative electrode slurry. Next, the negative electrode slurry was applied onto copper foil, so that the mass of a negative electrode mixture per 1 m² of the copper foil was 190 g. The applied film was dried, and then rolled, to give a negative electrode with a negative electrode mixture layer having a density of 1.5 g/cm³ formed on both sides of the copper foil.

[Production of Positive Electrode]

A lithium-nickel composite oxide (LiNi_{0.8}Co_{0.18}Al_{0.02}O₂) was mixed with acetylene black and polyvinylidene fluoride in a mass ratio of 95:2.5:2.5, to which N-methyl-2-pyrrolidone (NMP) was added. The mixture was stirred in a mixer (T.K. HIVIS MIX, available from PRIMIX Corporation), to prepare a positive electrode slurry. Next, the positive electrode slurry was applied onto aluminum foil. The applied film was dried, and then rolled, to give a positive electrode with a positive electrode mixture layer having a density of 3.6 g/cm³ formed on both sides of the aluminum foil.

[Preparation of Non-Aqueous Electrolytic Solution]

A mixed solvent containing ethylene carbonate (EC), dimethyl carbonate (DMC), ethyl methyl carbonate (EMC), and methyl acetate serving as an ester compound C in a volume ratio of 20:68:10:2 was prepared. To the mixed solvent, methanol serving as an alcohol compound A, and acetic acid serving as a carboxylic acid compound B were added each at a concentration of 2 ppm relative to the total mass of the solution, to prepare a non-aqueous electrolyte solution. The methyl acetate had a purity of 99.9999%.

[Fabrication of Non-Aqueous Electrolyte Secondary Battery]

The positive electrode and the negative electrode, with a tab attached to each electrode, were wound spirally with a separator interposed therebetween such that the tab was positioned at the outermost layer, thereby to form an electrode group. The electrode group was inserted into an outer case made of aluminum laminated film and dried under vacuum at 105° C. for 2 hours. The non-aqueous electrolytic solution was injected into the case, and the opening of the outer case was sealed. A battery A1 was thus obtained.

### EXAMPLES 2 TO 8

The the alcohol compound A, the carboxylic acid compound B, and the ester compound C were each added in an amount as shown in Table 1, to prepare an electrolytic solution. In Examples 2 to 8, while increasing or decreasing the amount of the ester compound C in the electrolytic solution, the amount of dimethyl carbonate (DMC) was decreased or increased. A positive electrode and a negative electrode were prepared and batteries A2 to A8 of Examples 2 to 8 were fabricated in the same manner as in Example 1 except the above.

### COMPARATIVE EXAMPLE 1

An electrolytic solution was prepared such that ethylene carbonate (EC), dimethyl carbonate (DMC), and ethyl methyl carbonate (EMC) were contained in a volume ratio of 20:70:10. The alcohol compound A, the carboxylic acid compound B, and the ester compound C were not added to the electrolytic solution. A positive electrode and a negative electrode were prepared and a battery B1 of Comparative Example 1 was fabricated in the same manner as in Example 1 except the above

### COMPARATIVE EXAMPLE 2

An electrolytic solution was prepared such that ethylene carbonate (EC), dimethyl carbonate (DMC), ethyl methyl carbonate (EMC), and methyl acetate serving as the ester compound C were contained in a volume ratio of 20:60:10:10. The alcohol compound A and the carboxylic acid compound B were not added to the electrolytic solution. A positive electrode and a negative electrode were prepared, and a battery B2 of Comparative Example 2 was fabricated in the same manner as in Example 1 except the above.

### COMPARATIVE EXAMPLE 3

LiNi_{0.5}Co_{0.2}Mn_{0.3}O₂ was used as the positive electrode material. The alcohol compound A, the carboxylic acid compound B, and the ester compound C were each added in an amount as shown in Table 1, to prepare an electrolytic solution. Ethylene carbonate (EC), dimethyl carbonate (DMC), ethyl methyl carbonate (EMC), and methyl acetate serving as the ester compound C were contained in a volume ratio of 20:45:10:25. A positive electrode and a negative electrode were prepared, and a battery C of Comparative Example 3 was fabricated in the same manner as in Example 1 except the above.

[Analysis of Electrolytic Solution in Battery]

The fabricated batteries were each subjected to a constant-current charge at a current of 0.3 It (800 mA) until the voltage reached 4.2 V, and then to a constant-voltage charge at a voltage of 4.2 V until the current reached 0.015 It (40 mA). Thereafter, the batteries were subjected to a constant-current discharge at 0.3 It (800 mA) until the voltage reached 2.75 V.

With the rest time between charge and discharge set to 10 minutes, charge and discharge were repeated 5 cycles in total under the charge and discharge conditions as mentioned above. Thereafter, the batteries were disassembled, to analyze the components of the electrolytic solution by gas chromatography mass spectrometry (GCMS). The amounts of the alcohol compound A and the carboxylic acid compound B (the mass ratio relative to the whole electrolyte) obtained by the analysis are shown in Table 1.

The GCMS measurement conditions used for the analysis of the electrolytic solution were as follows.

Apparatus: GC 17A, GCMS-QP5050A, available from Shimadzu Corporation

Column: HP-1 (film thickness: 1.0 μm×length 60 m), available from Agilent Technologies, Inc.

Column temperature: 50° C.→110° C. (5° C./min, hold 12 min)→250° C. (5° C./min, hold 7 min)→300° C. (10° C./min, hold 20 min)

Split ratio: 1/50

Linear velocity: 29.2 cm/s

Inlet temperature: 270° C.

Injection amount: 0.5 μL

Interface temperature: 230° C.

Mass range: m/z=30 to 400 (SCAN mode), m/z=29, 31, 32, 43, 45, 60 (SIM mode)

TABLE 1

| | Electrolytic solution (at the time of preparation) | | | | | | Analysis result of electrolytic solution | |
|---|---|---|---|---|---|---|---|---|
| | | | Carboxylic acid | | Alcohol | | Carboxylic acid | Alcohol |
| Battery | Ester compound C | Vol % | compound B | ppm | compound A | ppm | compound B ppm | compound A ppm |
| A1 | methyl acetate | 2 | acetic acid | 2 | methanol | 2 | 18 | 16 |
| A2 | methyl acetate | 5 | acetic acid | 5 | methanol | 5 | 22 | 26 |
| A3 | methyl acetate | 45 | acetic acid | 20 | methanol | 25 | 28 | 37 |
| A4 | methyl acetate | 55 | acetic acid | 35 | methanol | 40 | 52 | 58 |
| A5 | ethyl acetate | 20 | acetic acid | 40 | ethanol | 35 | 60 | 43 |
| A6 | propyl acetate | 20 | acetic acid | 25 | propanol | 35 | 31 | 41 |
| A7 | methyl propionate | 20 | propionic acid | 40 | methanol | 30 | 58 | 53 |
| A8 | methyl acetate | 20 | — | — | methanol | 20 | 33 | 43 |
| B1 | — | — | — | — | — | — | — | — |
| B2 | methyl acetate | 10 | — | — | — | — | 8 | 10 |
| B3 | methyl acetate | 25 | acetic acid | 31 | methanol | 37 | 50 | 58 |

The batteries A1 to A8 of Examples 1 to 8 and the batteries B1 to B3 of Comparative Examples 1 to 3 were evaluated as follows. The evaluation results are shown in Table 2.

[Initial Charge Capacity]

A constant-current charge was performed at a current of 0.3 It (800 mA) until the voltage reached 4.2 V, and then a constant-voltage charge was performed at a voltage of 4.2 V until the current reached 0.015 It (40 mA). This was followed by a constant-current discharge at 0.3 It (800 mA) until the voltage reached 2.75 V. The discharge capacity D1 at this time was measured as a battery capacity.

[Cycle Retention Ratio]

A constant-current charge was performed at a current of 0.3 It (800 mA) until the voltage reached 4.2 V, and then a constant-voltage charge was performed at a voltage of 4.2 V until the current reached 0.015 It (40 mA). This was followed by a constant-current discharge at 0.3 It (800 mA) until the voltage reached 2.75 V.

With the rest time between charge and discharge set to 10 minutes, charge and discharge were repeated under the charge and discharge conditions as mentioned above. The ratio of the discharge capacity at the 300^{th} cycle to the discharge capacity at the 1^{st} cycle was calculated as a cycle retention ratio. The charge and discharge were performed in a 25° C. environment.

[Storage Capacity Retention Ratio]

The batteries after the initial charge were left to stand for a long period of time (one month) in a 60° C. environment. After the time had passed, the batteries were subjected to a constant-current discharge at 0.3 It (800 mA) until the voltage reached 2.75 in a 25° C. environment, to measure a discharge capacity. The ratio of the discharge capacity to the initial charge capacity was calculated as a storage capacity retention ratio.

TABLE 2

| | | | 60° C. for 1 month |
|---|---|---|---|
| | Charge | 300 cycles | storage capacity |
| | capacity | retention ratio | retention ratio |
| Battery | [mAh] | [%] | [%] |
| A1 | 2680 | 78 | 74 |
| A2 | 2741 | 85 | 95 |
| A3 | 2755 | 86 | 94 |
| A4 | 2746 | 87 | 91 |
| A5 | 2738 | 83 | 92 |
| A6 | 2744 | 82 | 93 |
| A7 | 2725 | 80 | 92 |
| A8 | 2736 | 81 | 90 |
| B1 | 2719 | 62 | 74 |
| B2 | 2724 | 68 | 70 |
| B3 | 2177 | 75 | 77 |

Table 2 shows that the batteries A1 to A8, in which in addition to the ester compound C, the alcohol compound A or the carboxylic acid compound B constituting the ester compound C was added to the electrolytic solution in advance, were non-aqueous electrolyte secondary batteries having a high capacity and a high cycle retention ratio, as well as excellent high-temperature storage characteristics.

In the battery B1 containing no ester compound C, the cycle retention ratio was low. In the battery B2 containing the ester compound C, the cycle retention ratio was slightly improved as compared to the battery B1. As compared to the battery A1, however, the cycle retention ratio of the battery B2 was low. With respect to the high-temperature storage characteristics also, the battery B2 was inferior to the battery B1. This was presumably because exposure to strong alkali and high temperatures caused the decomposition reaction of the ester compound C to be accelerated.

In the battery B3, in which the Ni ratio in the lithium-nickel composite oxide used for the positive electrode was low, the capacity was considerably smaller than that of the other batteries A1 to A7, B1, and B2.

In contrast, the batteries A1 to A8 showed a large capacity and a high cycle retention ratio, and were excellent in high-temperature storage characteristics. This was presumably because, due to the presence of the alcohol compound A or the carboxylic acid compound B in the electrolytic solution, the equilibrium of the esterification reaction had shifted to the formation side of the ester compound C. Therefore, the decomposition reaction of the ester compound C was difficult to proceed even in a high temperature environment, hardly deteriorating the storage characteristics.

### INDUSTRIAL APPLICABILITY

According to the non-aqueous electrolyte secondary battery of the present invention, a non-aqueous electrolyte secondary battery having a high capacity and excellent high-temperature storage characteristics can be provided. The non-aqueous electrolyte secondary battery of the present invention is useful as a main power source for mobile communication devices, portable electronic devices, and others.

### REFERENCE SIGNS LIST

4: frame body

5: sealing plate

6: battery case

9: electrode group

11: negative electrode lead

13: negative electrode terminal

14: positive electrode lead

1. A non-aqueous electrolyte secondary battery, comprising
a positive electrode, a separator, a negative electrode facing the positive electrode with the separator interposed between the positive electrode and the negative electrode, and an electrolytic solution containing a solvent and an electrolyte,
the positive electrode including a positive electrode material containing a lithium-nickel composite oxide represented by LiₐNi_{b}M_{1-b}O₂, where M represents at least one selected from the group consisting of Na, Mg, Sc, Y, Mn, Fe, Co, Ni, Cu, Zn, Al, Cr, Pb, Sb and B, 0.95≤a≤1.2, and 0.8≤b≤1,
the electrolytic solution containing an ester compound C of an alcohol compound A and a carboxylic acid compound B, and containing at least one of the alcohol compound A and the carboxylic acid compound B in an amount of 15 ppm or more, relative to a mass of the electrolytic solution.

2. The non-aqueous electrolyte secondary battery of claim 1, wherein the element M constituting the lithium-nickel composite oxide is at least one selected from the group consisting of Mn, Co and Al.

3. The non-aqueous electrolyte secondary battery of claim 1, wherein the alcohol compound A is contained in an amount of 15 to 1000 ppm, relative to the mass of the electrolytic solution.

4. The non-aqueous electrolyte secondary battery of claim 1, wherein the carboxylic acid compound B is contained in an amount of 15 to 1000 ppm, relative to the mass of the electrolytic solution.

5. The non-aqueous electrolyte secondary battery of claim 1, wherein the ester compound C is contained in an amount of 1 to 80%, relative to a volume of the electrolytic solution.

6. The non-aqueous electrolyte secondary battery of claim 1, wherein the alcohol compound A includes at least one selected from the group consisting of monoalcohols having 1 to 4 carbon atoms.

7. The non-aqueous electrolyte secondary battery of claim 6, wherein the alcohol compound A includes methanol.

8. The non-aqueous electrolyte secondary battery of claim 1, wherein the carboxylic acid compound B includes at least one selected from the group consisting of monocarboxylic acids having 2 to 4 carbon atoms.

9. The non-aqueous electrolyte secondary battery of claim 8, wherein the carboxylic acid compound B includes acetic acid.
